(19) United States
(12) Patent Application Publication
(10) Pub. No.: US 2018/0071944 A1
(43) Pub. Date: Mar. 15, 2018

(54) WOOD DRYING AND PRESERVATION METHODS

(71) Applicant: University of Houston System, Houston, TX (US)

(72) Inventors: Seamus Curran, Houston, TX (US); Kang-Shyang Liao, Houston, TX (US); Nigel J. Alley, Houston, TX (US); Amrita Haldar, Dublin, CA (US); Surendra Maharjan, Houston, TX (US)

(73) Assignee: University of Houston System, Houston, TX (US)

(21) Appl. No.: 15/558,911

(22) PCT Filed: Apr. 1, 2016
(86) PCT No.: PCT/US16/25498

§ 371 Date: Sep. 15, 2017

Related U.S. Application Data
(60) Provisional application No. 62/141,379, filed on Apr. 1, 2015.

(51) Int. Cl. B27K 5/04; F26B 3/04; B27K 3/08

(52) U.S. Cl. CPC B27K 5/04; B27K 2240/10; B27K 3/08; F26B 3/04

(57) ABSTRACT

The new methods for treating green wood discuss herein speed up air drying of common green wood, including both softwood and hardwood. This method involves treating and altering the green wood with a base solution, and subjecting the wood to an air drying process. The new methods require less time to dry the green wood to a desired water content. In addition, other additives may be included in the base solution such as miscibility solvent(s), preservative(s), solubilizer(s)/stabilizer(s), chelating agent(s), bonding agent(s), pigment(s), UV protective, anti-oxidant, anti-fungal, anti-microbial and/or anti-insect chemical(s). The base solution solution may also slow down the wood deterioration caused by physical, chemical and biological sources under ambient conditions.

### RELATED APPLICATIONS

This application claims the benefit of U.S. Provisional Patent Application No. 62/141,379 filed on Apr. 1, 2015, which is incorporated herein by reference.

### FIELD OF THE INVENTION

The present invention relates to induced wood drying and preservation methods. More specifically, it is related to a solution based process for the removal of water from green wood or lumber.

### BACKGROUND OF THE INVENTION

The wood of a living tree contains large quantities of water. Green wood or lumber is wood that has been recently cut and has not been seasoned or dried of internal moisture. It may be desirable to remove the moisture or water from the green wood or lumber to some degree to make the wood suitable for a various applications. The process of drying or removing water from the wood may be referred to as ‘drying’ or ‘seasoning’. Water content may vary depending on the particular type and location of the wood. For example, sapwood may have a water content between 120 to 200% of the oven-dry weight of the wood, while heartwood may content water between 40 to 60%. Dried wood is often referred to as ‘seasoned wood’.

There are two techniques used to dry green wood, namely air drying and kiln drying. The drying process may stabilize the wood to minimize shrinkage or expansion in a final-product or end-product. When air drying, green wood is processed by arranging it in the form of stacked cut lumbers appropriately spaced and ventilated. The wood is left to dry passively in ambient air. This technique is climate dependent and generally a slow process. Passive air-drying is a simple and mild process (relative to kiln drying) that does not subject the wood to high temperatures or high internal moisture gradients that may cause internal stress, which may be present in other drying processes such as kiln drying. Because the final moisture content is determined by ambient air temperature, relative humidity and drying time, air drying wood can bring the moisture content down to a range centered about ˜20% by weight. Depending on outside conditions, lumber species and size, air-drying may take up to several months to several years to obtain desired moisture content. In addition, prolonged drying under ambient conditions also raises other concerns. First, lumber is susceptible to fungi, mold and insect infestation when stored under ambient conditions, which may not provide temperatures high enough to prevent fungi, mold or insect infestation. Second, lumber is also susceptible to chemical reaction with chemicals or bacteria from the environment that can cause staining of lumber. Third, lumber can become weathered from ultraviolet radiation, dirt and other contaminants. Fourth, for highly resinous species, the resin can cause the wood to change color and appear darker than desired due to oxidation.

In kiln drying, green wood or lumber is placed in an insulated chamber that heated air is circulated in. While this technique has some benefits in comparison to air drying, it can also result in other undesirable effects. For example, kiln drying may result in kiln stains or a higher internal moisture gradient stresses that can cause a higher rate of checking or warping of the wood. This may be caused by the inner walls collapsing, giving rise to the appearance of shrunk and often times cracked wood. These effects can reduce the wood quality, yield and value. These problems may be mitigated by regulating the temperature and humidity of the circulating air to control the moisture content of the lumber at any given time, such as by applying kiln drying schedules. However, because many factors, such as the wood species, thickness of the lumber, sawing pattern and the intended use of the lumber, can affect the drying parameters, kiln drying can become a very complicated and sophisticated operation that requires specialized equipment and skilled workers. Not surprisingly, this results in higher cost.

For wood species that are highly susceptible to checking and warping due to high internal moisture gradient stresses caused by kiln drying, a combination method is often used. Green wood may be air dried first to a moisture content of ˜25% before drying the wood to a lower moisture content (e.g. 6-12%) in a low temperature dry kiln. However, such combined operations can be time consuming (several months to several years) and therefore occupy a large footprint before any usable dried wood can be produced.

Other techniques used to dry wood include superheated steam (U.S. Pat. No. 918,335), solvent extraction (U.S. Pat. Nos. 2,500,783 and 2,860,070), freeze drying (U.S. Pat. Nos. 2,534,714 and 3,309,778), boiling in oil (U.S. Pat. No. 3,205,589), vacuum drying (U.S. Pat. No. 3,571,943), radio/microwave heating (U.S. Pat. 3,721,013), high frequency dielectric heating (U.S. Pat. No. 4,466,198), infrared heating (U.S. Pat. No. 5,557,858), and extraction using supercritical carbon dioxide (U.S. Pat. No.8,578,625 B2). However, most of these techniques require sophisticated equipment, well-controlled environments and are energy intensive.

There are several aspects of the current wood drying practices that may be improved including reducing drying time, reducing exposure to conditions that may cause deterioration, and simplifying the process and/or equipment utilized.

### SUMMARY OF THE INVENTION

Methods for wood drying and preservation are discussed herein that offer new methods to speed up air drying of green wood or lumber, including both softwood and hardwood. In one embodiment, the method may involve introducing the green wood to a base solution, which may be applied by any suitable process such as either passive means that include dipping, soaking or spraying, and/or active means that include applying pressure/increased temperature to infuse the solution into the wood. In some embodiments, the base solution may contain miscibility solvent(s), which are fully or partially miscible with water and have lower boiling points than water, to exchange water from inside the wood structure. After applying the solution, it interpenetrates or soaks into the wood structure. The green wood may then be air dried using any suitable air drying.

In some embodiments, preservatives may be added into wood using base solutions that form hydrophobic layers from the inside out while and/or selective additives to inhibit degradation. The selective additives may provide UV protection, anti-oxidant, anti-fungal, anti-microbial and anti-insect treatments. In some embodiments, the preservative(s) may slow down wood deterioration caused by physical, chemical and biological sources under ambient conditions. In some embodiments, the base solution may include solubilizer(s)/stabilizer(s) to increase the solubility of preservatives in the solution and/or to stabilize the preservative(s) to form an emulsion or homogeneous solution. In some embodiments, the base solution may include chelating agent(s) to enhance homogeneity of the organic/inorganic preservative(s) in the solution. In some embodiments, the base solution may include bonding agent(s) to aid bonding of the preservative(s) to the surface of wood vessels. The preservative(s) may prevent leaching of preservative(s) under ambient conditions, high temperature, high humidity, and/or in the presence of contaminants. In some embodiments, it is desirable to impart some additional properties to wood, whilst retaining or improving the original appearance. This may be the case for visibility and contrast of the wood grain as seen after treatment. One or more pigments, which do not impair or only have a minimal effect on the original functions of the base solution, may be added into the solution.

In some embodiments, the base solution is prepared by mixing at least one of the solvent(s), preservative(s), solubilizer(s)/stabilizer(s), chelating agent(s), bonding agent(s), pigment(s) and water. The mixture of the aforementioned chemical agents may be stirred at an elevated temperature. As a nonlimiting example, the mixture may be stirred at equal to or between about 50 to 100° C. for equal to or between about 30 minutes to 10 days. In some embodiments, the base solution may be diluted with more solvent(s). In some embodiments, the organic/inorganic composite solution is at least partial hydrolyzed or completely hydrolyzed.

In some embodiments, green wood is treated with the first base solution, followed by an air drying schedule until the wood reaches the desired moisture content. In some embodiments, the first solution treatment/air drying procedure may be repeated as many times as desired to speed up the drying process or to increase the contents of preservatives absorbed by wood. In some embodiments, the wood may be optionally treated with a second base solution to impart other properties (e.g. higher preservative concentration, pigmentation and/or surface treatment) before the final steps to yield a final product.

In some embodiments, pretreated wood using preservatives or pesticides, such as creosote, can be sealed off using the base solution including silane based additives to seal the outside of the wood and to prevent leaching of the internal treatments. These solutions may also contain additional preservative molecules, including inorganic/organic dyes, molecules or pigments, to prevent damage from UV, oxidative processes, insects, microbes, and/or bacteria. In some embodiments, pretreated wood, where inorganic and organic dyes/pigments are already infused into the wood, can be sealed off using the base solution including silane based additives that may also contain additional preservative molecules, including inorganic/organic dyes, molecules or pigments, to prevent damage from UV, oxidative processes, insects, microbes, or bacteria.

The foregoing has outlined rather broadly various features of the present disclosure in order that the detailed description that follows may be better understood. Additional features and advantages of the disclosure will be described hereinafter.

### BRIEF DESCRIPTION OF THE DRAWINGS

For a more complete understanding of the present disclosure, and the advantages thereof, reference is now made to the following descriptions to be taken in conjunction with the accompanying drawings describing specific embodiments of the disclosure, wherein:

FIG. 1 shows an illustration of wood drying schedule using base solution treatment;

FIG. 2 shows the reduction of Douglas Fir (Pseudotsuga menziesii) moisture content oven time after base solution treatment using different solvents;

FIG. 3 shows the weight % moisture content in Douglas Fir oven time after base solution treatment using methanol;

FIG. 4 shows the weight % moisture content in Pecan oven time after base solution treatment using ethanol; and

FIG. 5 shows the appearance of Western Red Cedar boards treated with the same colored base solution while at various moisture content.

### DETAILED DESCRIPTION OF THE INVENTION

Referring to the drawings in general, it will be understood that the illustrations are for the purpose of describing particular implementations of the disclosure and are not intended to be limiting thereto. While most of the terms used herein will be recognizable to those of ordinary skill in the art, it should be understood that when not explicitly defined, terms should be interpreted as adopting a meaning presently accepted by those of ordinary skill in the art.

It is to be understood that both the foregoing general description and the following detailed description are exemplary and explanatory only, and are not restrictive of the invention, as claimed. In this application, the use of the singular includes the plural, the word “a” or “an” means “at least one”, and the use of “or” means “and/or”, unless specifically stated otherwise. Furthermore, the use of the term “including”, as well as other forms, such as “includes” and “included”, is not limiting. Also, terms such as “element” or “component” encompass both elements or components comprising one unit and elements or components that comprise more than one unit unless specifically stated otherwise.

It shall be understood that green wood or green lumber refers to wood that has been recently cut and/or has not been subjected to a treatment process, such as air drying or kiln drying, to remove internal moisture. Wood that has been subjected to a treatment process to remove moisture may be referred to herein as dried wood or seasoned wood.

Methods for wood drying and preservation are discussed herein. These new methods speed up air drying of green wood or green lumber, including both softwood and hardwood. The methods may include treating the green wood or lumber with a base solution, which may be applied by any suitable process. In some embodiments, the application may be passive means including, but not limited to, dipping, soaking or spraying the green wood, or active means including, but not limited to, applying increased pressure and/or temperature to the green wood to infuse the solution into the wood.

In some embodiments, the base solution may contain miscibility solvent(s), which are fully or partially miscible with water and have lower boiling points than water, to exchange water from inside the wood structure. In some embodiments, the base solution may be organic. However, the base solution may be mixed with inorganic additives in some embodiments. After application, the green wood may be air dried using any suitable air drying process. Comparing to other air drying, the new methods may require less time to dry the green wood to the desired water content due to (1) the green wood already having a lower water content after the base solution interpenetrates the wood structure; and (2) the water/solvent(s) mixture inside the wood structure evaporating faster because the boiling point of the water/solvent(s) mixture is lower than water alone.

In some embodiments, the base solution may include preservative(s), which are used to slow down the wood deterioration caused by physical, chemical and/or biological sources under ambient conditions. In some embodiments, the base solution may include solubilizer(s)/stabilizer(s) to increase the solubility of preservatives in the solution and/or to stabilize the preservative(s) to form an emulsion or homogeneous solution. In some embodiments, the base solution may include chelating agent(s) to enhance homogeneity of the organic/inorganic preservative(s) in the solution. In some embodiments, the base solution may include bonding agent(s) to aid bonding of the preservative(s) to the surface of wood vessels and thus to prevent leaching of preservative(s) under ambient conditions and/or under increased temperature or moisture conditions.

In some embodiments, the miscibility solvent(s) used to disperse all the components to form an emulsion or homogeneous solution may include, but are not limited to, Acetone, Acetonitrile, tent-Butanol, Carbon tetrachloride, Chloroform, Cyclohexane, Cyclopentane, Dichloromethane, Diethyl ether, Ethanol, Ethyl acetate, Ethyl ether, Ethylene dichloride, Heptane, n-Hexane, Methanol, Methylene chloride, Methyl tent-butyl ether, Pentane, Petroleum ethers, Isopropanol, n-Propanol, Tetrahydrofuran or a mixture thereof.

In some embodiments, the preservative(s), which are used to reduce or slow down the wood deterioration caused by physical or/and chemical sources under ambient conditions may include, but are not limited to, chemicals that protect the wood from degradation caused by exposure to ultraviolet radiation, such as ultraviolet light absorbers. Nonlimiting examples of such chemicals may include 2-hydroxyphenyl-benzophenones, 2-(2-hydroxyphenyl)-benzotriazole and/or 2-hydroxyphenyl-s-triazines derivatives.

In some embodiments, the preservative(s) may include chemicals that protect the wood from degradation caused by free radicals, such as hindered-amine light stabilizers. Nonlimiting examples of such chemicals may include tetramethyl piperidine derivatives. In some embodiments, the preservative(s) may include antioxidants that protect the wood from degradation caused by oxidants. Nonlimiting examples of such chemicals may include sterically hindered phenols, phosphites and/or thioethers.

In some embodiments, the preservative(s), which are used to slow down the wood deterioration caused by biological sources under ambient conditions, may include pesticide, fungicide and/or biocide. Nonlimiting examples of such chemicals may include Acid copper chromate, Ammoniacal copper arsenate, Ammoniacal copper citrate, Ammoniacal copper zinc arsenate, Alkaline copper quaternary compounds, Boric acid, Borates complexes, Creosote, Chromated copper arsenate, Copper azoles, Copper dimethyldithiocarbamate, Copper naphthenate, Copper-8-quinolinolate, 3-Iodo-2-propynyl butyl carbamate and/or Pentachlorophenol. In some embodiments, the preservative(s) may include repellents that ward off wood eating or burrowing insects, such as termites. Nonlimiting examples of such chemicals may include cedar oil and/or neem seed oil.

In some embodiments, solubilizer(s)/stabilizer(s) to increase the solubility of preservatives in the solution and/or to stabilize the preservative(s) to form an emulsion or homogeneous solutions may include at least one alkoxysilane, metal oxide precursor or a combination thereof having a general formula of M(OR)₄ (M=Si, Al, Ti, In, Sn or Zr), where R comprises hydrogen, a substituted or unsubstituted alkyl or derivatives thereof. Nonlimiting examples of such chemicals include tetramethyl orthosilicate, tetraethyl orthosilicate, tetraisopropyl orthosilicate, tetra(tert-butyl) orthosilicate, tetra(sec-butyl) orthosilicate, aluminum methoxide, aluminum ethoxide, aluminum isopropoxide, aluminum tert-butoxide, aluminum tri-sec-butoxide, titanium methoxide, titanium ethoxide, titanium isopropoxide, titanium tert-butoxide, titanium tri-sec-butoxide and/or derivatives bearing similar structures.

In some embodiments, the chelating agent(s) to enhance homogeneity of the organic/inorganic preservative(s) in the solution may comprise at least one alkoxysilane, metal oxide precursor or a combination thereof having a general formula of M(OR)ₓ R′_{y} R″_{z} (M=Si, Al, In, Sn or Ti; x is the integer 1, 2 or 3; y is the integer 0, 1 or 2; z is the integer 1, 2 or 3, provided that the sum of x, y and z equals 4), where R comprises hydrogen, a substituted or unsubstituted alkyl or derivatives thereof; R′ comprises hydrogen, a substituted or unsubstituted alkyl or derivatives thereof and R″ comprises a substituted or unsubstituted amine (including primary, secondary and tertiary) or thiol. The enhanced homogeneity of preservative(s) provided by the chelating agent(s) results in a more uniform treatment of the green wood, thereby minimizing regions different preservative concentration. Nonlimiting examples of such chemicals includes 3-aminopropyltrimethoxysilane, 3-aminopropyltriethoxysilane, 2-aminoethyltrimethoxysilane, 2-aminoethyltriethoxysilane, N-methylaminopropyltrimethoxysilane, N-methylaminopropyltriethoxysilane 4-aminobutylmethyldimethoxysilane, 4-aminobutylmethyldiethoxysilane, 3-aminopropyldimethylmethoxysilane, 3-aminopropyldimethylethoxysilane, 3-aminopropylmethyldimethoxysilane, 3-aminopropylmethyldiethoxysilane, N,N-dimethyl-3-aminopropyltrimethoxysilane, N,N-dimethyl-3-aminopropyltriethoxysilane, N,N-diethyl-3-aminopropyltrimethoxysilane, N,N-diethyl-3-aminopropyltriethoxysilane, N,N-diethylaminomethyltrimethoxysilane, N,N-diethylaminomethyltriethoxysilane, bis(2-hydroxyethyl)-3-aminopropyltrimethoxysilane, bis(2-hydroxyethyl)-3-aminopropyltriethoxysilane, N-(2′-aminoethyl)-3-aminopropyltrimethoxysilane, N-(2′-aminoethyl)-3-aminopropyltriethoxysilane, N-butyl-3-aminopropyltrimethoxysilane, N-butyl-3-aminopropyltriethoxysilane, N-octyl-3-aminopropyltrimethoxysilane, N-octyl-3-aminopropyltriethoxysilane, N-cyclohexyl-3-aminopropyltrimethoxysilane, N-cyclohexyl-3-aminopropyltriethoxysilane, N-(3′-trimethoxysilylpropyl)-piperazine, N-(3′-triethoxysilylpropyl)-piperazine, N-(3′-trimethoxysilylpropyl)morpholine, N-(3′-triethoxysilylpropyl)morpholine, bis(3-trimethoxysilylpropyl)amine, bis(3-triethoxysilylpropyl)amine, tris(3-trimethoxysilylpropyl)amine, tris(3-triethoxysilylpropyl)amine, N-methyl-N-butyl-3-aminopropyltrimethoxysilane, N-methyl-N-butyl-3-aminopropyltriethoxysilane, N-(3′-aminopropyl)-3-aminopropyltrimethoxysilane, N-(3′-aminopropyl)-3-aminopropyltriethoxysilane, N-phenyl-3-aminopropyltrimethoxysilane, N-phenyl-3-aminopropyltriethoxysilane, 3-mercaptopropyltrimethoxysilane, 3-mercaptopropyltriethoxysilane and/or derivatives bearing similar structures.

In some embodiments, the bonding agent(s) to aid bonding of the preservative(s) to the surface of wood vessels may include at least one alkoxysilane, metal oxide precursor or a combination thereof having a general formula of M(OR)ₓ R′_{y} R″_{z} (M=Si, Al, In, Sn or Ti; x is the integer 1, 2 or 3; y is the integer 0, 1 or 2; z is the integer 1, 2 or 3, provided that the sum of x, y and z equals 4), where R comprises hydrogen, a substituted or unsubstituted alkyl or derivatives thereof; R′ comprises hydrogen, a substituted or unsubstituted alkyl or derivatives thereof and R″ comprises a substituted or unsubstituted epoxy or glycidoxy. The enhanced bonding of preservative(s) to the surface of the green wood provided by the bonding agent(s) results in the reduction or elimination of preservative leaching. The bonding agent(s) may seal in or provide a seal-like effect that reduces or prevents preservative leaching. Nonlimiting examples of such chemicals includes 2-(3,4-epoxycyclohexyl)ethyltrimethoxysilane, 2-(3,4-epoxycyclohexyl)-ethyltriethoxysilane, 5,6-epoxyhexyltrimethoxysilane, 5,6-epoxyhexyltriethoxysilane, glycidoxymethyltrimethoxysilane, glycidoxymethyltriethoxysilane, 2-glycidoxyethyltrimethoxysilane, 2-glycidoxyethyltriethoxysilane, 3-glycidoxypropyltrimethoxysilane, 3-glycidoxypropyltriethoxysilane, 4-glycidoxybutyltrimethoxysilane, 4-glycidoxybutyltriethoxysilane and/or derivatives bearing similar structures.

In some embodiments, it is desirable to impart some additional properties to wood whilst retaining or improving the original appearance. This may particularly be the case for the visibility and contrast of the wood grain as seen after treatment. In some embodiments, one or more pigments, which do not impair or only have a slight effect on the original functions of the base solution, may be added into the solution. Such pigments may include materials that change the color of reflected or transmitted light as the result of wavelength-selective absorption. Nonlimiting examples include the range of wavelengths humans can or cannot perceive, such as visible light having wavelength from approximately 390 to 700 nm; ultraviolet light having wavelengths approximately 100 to 390 nm and infrared and lower energy radiation having wavelengths from approximately 700 nm to 1 mm. The pigments may include, but are not limited to, metal-based inorganic pigments containing metal elements such as Cadmium, Chromium, Cobalt, Copper, Iron oxide, Lead, Manganese, Mercury, Titanium, Tellurium, Selenium and/or Zinc; other inorganic pigments such as Carbon, Clay earth and Ultramarine; organic pigments such as alizarin, alizarin crimson, gamboge, carmine, purpurin, indigo, Indian yellow, Tyrian purple, quinacridone, magenta, phthalo green, phthalo blue, diarylide yellow, pigment red, pigment yellow, pigment green, pigment blue and/or other inorganic or organic derivatives thereof. In some embodiments, pigments may also include materials that emit colors, such as through fluorescence, phosphorescence, and/or other forms of luminescence. Such pigments may include, but are not limited to, fluorophores, such as Fluorescein, Rhodamine, Coumarin, Cyanine and/or their derivatives; or phosphorescent dyes such as Zinc sulfide, Strontium aluminate and/or their derivatives.

In some embodiments, the base solution is prepared by mixing at least one of the above noted miscibility solvent(s), preservative(s), solubilizer(s)/stabilizer(s), chelating agent(s), bonding agent(s), pigment(s) and/or water. In some embodiments, the base solution may include at least one miscibility solvent and solubilizer/stabilizer. However, other embodiments may optionally include one or more preservative(s), bonding agent(s), chelating agent(s), pigment(s), water, or a combination thereof. The mixture of the aforementioned chemical agents for the base solution may be prepared by mixing all components of the first solution present, and then the mixture may be stirred at elevated temperature equal to or between about 50 to 100° C. for 30 minutes or longer. In other embodiments, the mixture may be stirred for equal to or between 30 minutes to 10 days, one hour or longer, 12 hours or longer, 24 hours or longer, or any other suitable period of time. In some embodiments, the base solution may be further diluted with more solvent(s). In some embodiments, the organic/inorganic composite solution is at least partial hydrolyzed or completely hydrolyzed.

In some embodiments, green wood is treated with the first base solution, followed by the air drying schedule until the wood reached the desired moisture content. In some embodiments, the first solution treatment/air drying procedure may be repeated as many times as desired to speed up the drying process or to increase the contents of preservatives absorbed by wood. In the next step, the wood may be optionally treated with the second base solution to impart other properties (e.g. higher preservative concentration, pigmentation and/or surface treatment) before finishing up by kiln drying to yield the final product.

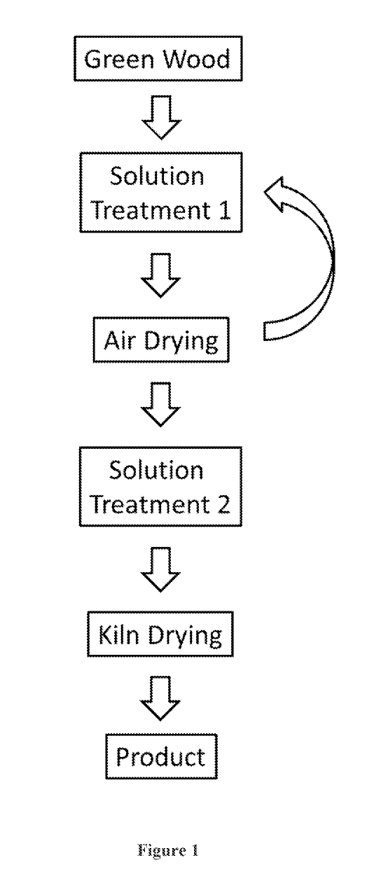

FIG. 1 shows an illustration of an improved wood drying and preservation method base solution. Green wood or lumber is treated in a first solution treatment, which is a base solution treatment as discussed above. In some embodiments, the green wood may be subjected to the 1^{st} solution treatment for equal to or between 1 minute to 1 month. In some embodiments, the green wood may be subjected to the 1^{st} solution treatment for equal to or between 1 hour to 24 hours. In some embodiments the green wood may be subjected to the 1^{st} solution treatment for 1 minute or longer, 30 minutes or longer, 1 hour or longer, 12 hours or longer, 24 hours or longer, 3 days or longer, 1 week or longer, 2 weeks or longer, or any other suitable period of time. After treatment, the wood may be subjected to any suitable air drying process. In some embodiments, the wood may be subjected to the air drying process for equal to or between 1 day to 3 years. The first solution treatment and air drying process may optionally be repeated as desired.

In some embodiments, it may be desirable to further treat the wood. This may optionally include treating the wood with a second solution treatment. In some embodiments, the second solution may be a base solution that shares the same components as the first solution, but does not need to be identical to the first solution. In such embodiments, the first base solution may be diluted with more solvent(s) to provide a higher concentration of the solvent than the second solution. This may allow the first base solution to be more effective in driving out moisture from the green wood, and the second solution to be more effective in sealing or imparting desired properties to the green wood. In some embodiments, the second solution may utilize a higher concentration of preservative(s) and/or pigment(s). The second solution may include miscibility solvent(s), preservative(s), solubilizer(s)/stabilizer(s), chelating agent(s), bonding agent(s), pigment(s) and/or water. Similar to the preparation methods discussed for the first solution, the second solution may be prepared by mixing all components present, and then this mixture may be stirred at elevated temperature equal to or between about 50 to 100° C. for 30 minutes or longer. In other embodiments, this mixture may be stirred for equal to or between 30 minutes to 10 days, one hour or longer, 12 hours or longer, 24 hours or longer, or any other suitable period of time. In some embodiments the wood may be optionally subjected to the 2^{nd} solution 0treatment for 1 minute or longer, 30 minutes or longer, 1 hour or longer, 12 hours or longer, 24 hours or longer, 3 days or longer, 1 week or longer, 2 weeks or longer, or any other suitable period of time. The wood may then optionally be subjected to any suitable kiln drying process to provide the desired end product or treated wood. In some embodiments, the wood may be subjected to the kiln drying process for equal to or between 1 hour to 1 week.

The drying process discussed herein depends on wood species, initial moisture content, cut size, drying temperature, humidity, or the like. It shall be understood that the following values may vary in accordance with differences in these variables. The following nonlimiting examples may apply to Douglas Fir with a moisture content of 40%. In some embodiments, the methods may result in about 20% or greater reduction of drying time in comparison to an air drying process without the treatment. In some embodiments, the methods may result in about 33% or greater reduction of drying time. In some embodiments, the methods may result in about 48% or greater reduction of drying time. In some embodiments, the methods may result in about 33% or greater reduction of drying time to reduce the moisture content level to about 20%. In some embodiments, the methods may result in about 48% or greater reduction of drying time to reduce the moisture content level to about 13%. In some embodiments, the methods may increase weight loss by at least 1%, such as in an equal amount of drying time compared to an air drying processes alone. In some embodiments, the methods may increase weight loss by at least 5%. In some embodiments, the methods may increase weight loss at least 1% in 24 hours of drying time, such as in comparison to an air drying processes alone. In some embodiments, the methods may increase weight loss by at least 5% in 24 hours of drying time. In some embodiments, the methods may reduce drying time to reach a desired weight reduction (e.g. % weight change from original weight) by about 1 hour or greater, such as in comparison to an air drying processes. In some embodiments, the methods may reduce drying time to reach a desired weight reduction by about 5 hours or greater. In some embodiments, the methods may reduce drying time to reach a desired weight reduction by about 10 hours or greater. In some embodiments, the methods may reduce drying time to bring the moisture content down to a range centered about 20% by weight (e.g. ±1%) by about 1 hour or greater, such as in comparison to an air drying processes. In some embodiments, the methods may reduce drying time to bring the moisture content down to a range centered about 5 hours or greater. In some embodiments, the methods may reduce drying time to bring the moisture content down to a range centered about 10 hours or greater. In some embodiments, for the same period of air drying time with an untreated sample, the solution treatment process yields an extra 1% reduction of moisture content. In some embodiments, for the same period of air drying time with the untreated sample, the solution treatment process yields an extra 3% reduction of moisture content. In some embodiments, for the same period of air drying time with the untreated sample, the solution treatment process yields an extra 5% reduction of moisture content.

In some embodiments, pretreated wood using preservatives or pesticides, such as creosote, can be sealed off using the base solution including silane based additives to seal the outside of the wood to prevent leaching of the internal treatments. These solutions may also contain additional preservative molecules including inorganic/organic dyes, molecules or pigments to prevent damage from UV, oxidative processes, insects, microbes, and bacteria. In some embodiments, pretreated wood with inorganic and organic dyes/pigments already infused can be sealed off using base solution including silane based additives that may also contain additional preservative molecules including inorganic/organic dyes, molecules or pigments to prevent damage from UV, oxidative processes, insects, microbes, and bacteria.

Experimental Example

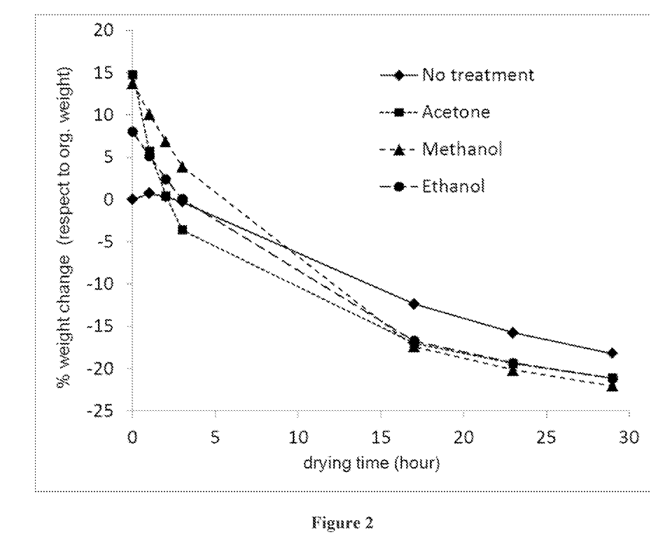

Douglas Fir (Pseudotsuga menziesii) (a softwood) was cut into pieces (3.5″×3.5″×2.0″). To obtain the ovendry weight, one sample was placed in the oven at 110° C. for a period of time until no more weight loses is observed. The moisture content of the original sample was determined to be 38.7%. Three duplicate samples were treated with base solutions made with three different solvents (acetone, methanol or ethanol) for 24 hours. The three solution treated sample and one untreated sample were dried in a 40° C. oven for an extended period of time. FIG. 2 shows the reduction of Douglas Fir moisture content over time after base solution treatment using different solvents. The treated samples increases in weight after a 24-hour organic solution treatment (14.8% for acetone, 13.7% for methanol and 8.0% for ethanol), indicating the organic solutions had infused into the wood structure and exchanged with the water inside the wood. The drying rates of solution treated samples for the first 17 hours are also higher than that of the untreated sample, indicating the water/solvent mixture inside the wood structure evaporates faster because the boiling point of the water/solvent(s) mixture is lower than that of water alone. After 17 hours, the drying rates of solution treated samples approach to that of the untreated sample, indicating most of the solvent already evaporates. For the same period of drying time, the solution treatment process yields an extra 5% reduction of moisture content comparing to air drying methods with the untreated sample (20% vs. 15% weight loss for a 24-hour drying period).

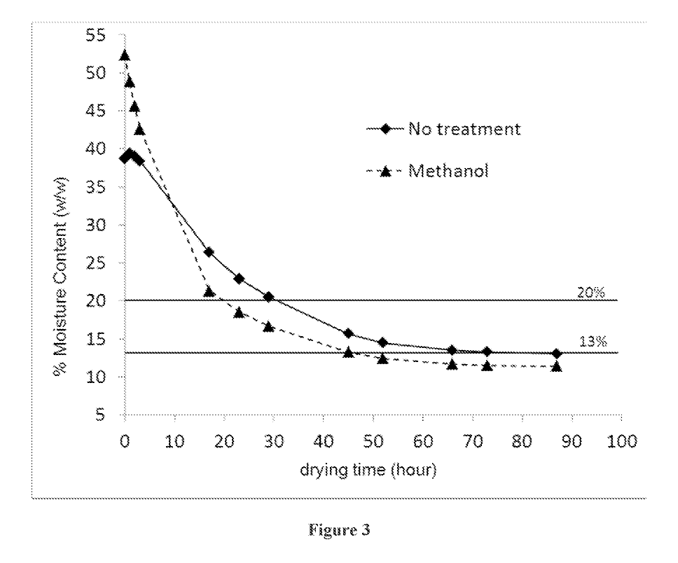

FIG. 3 shows the final weight % moisture content in Douglas Fir over drying time after base solution treatment using methanol as the solvent (the moisture content of the original sample is 38.7%). To reach a moisture content level of about 20%, the untreated sample required 30 hours of drying time while the treated one only required 20 hours. The difference is 10 hours or about 33% reduction of drying time. To reach a moisture content level of about 13%, the untreated sample requires 87 hours of drying time while the treated one only requires 45 hours. The difference is 42 hours or about 48% reduction of drying time. In addition, the moisture content level of the untreated sample no longer decreased (or was less than 0.1% per 12 hours) at about 13% after 87 hours, while the treated sample decreased to about 11% after 87 hours, indicating the treatment process can produce about 2% greater moisture content reduction when a moisture content plateau is reached.

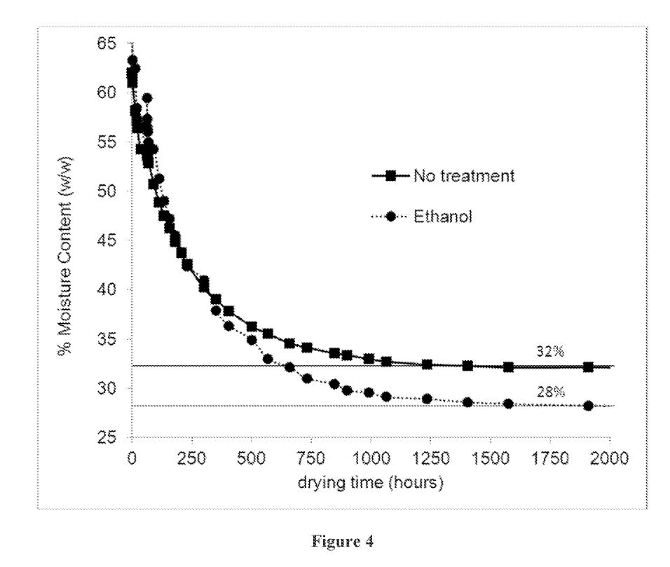

Pecan (Carya illinoinensis) (a hardwood) was cut into pieces (6.0″×6.0″×1.0″). To obtain the ovendry weight, one sample was placed in the oven at 110° C. for a period of time until no more weight loses is observed. The moisture content of the original sample was determined to be 62.1%. Duplicate samples were treated with base solutions made with ethanol for 24 hours. The solution treated sample and untreated sample were dried at ambient condition (indoor, room temperature) for an extended period of time. FIG. 4 shows the final weight % moisture content in Pecan over drying time after base solution treatment using ethanol as the solvent (the moisture content of the original sample is 62.1%). To reach a moisture content level of less than 32%, the untreated sample required 87 days (2075 hours) of drying time while the treated one only required 28 days (660 hours). The difference in drying time to achieve a moisture content level of less than 32% is 59 days or about 68% reduction of drying time. In addition, the moisture content level of the untreated sample no longer decreased (or was less than 0.1% per day) at about 32% after 58 days, while the treated sample decreased to about 28% after 58 days, indicating the treatment process can produce about 4% greater moisture content reduction when a moisture content plateau is reached.

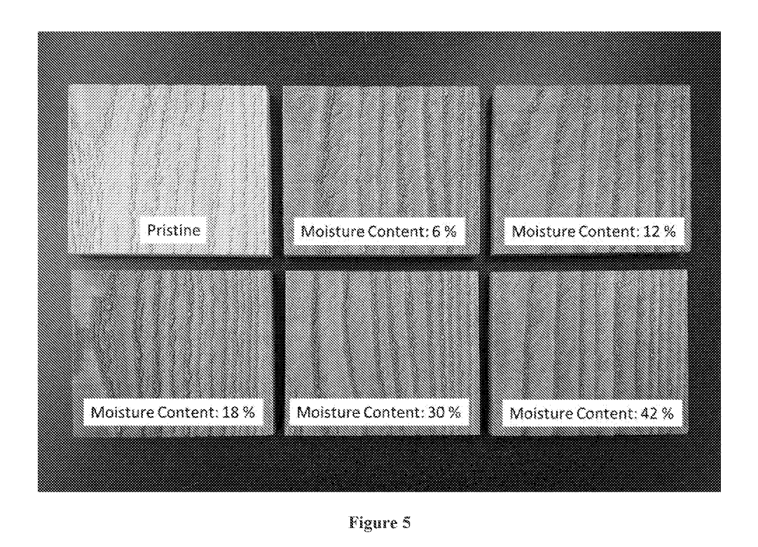

In addition to accelerating wood drying, the base solution can also be used to impart color to improve the original appearance of the nature wood. Common practice for impart color into the nature wood, or “staining”, requires the wood to be dried to the moisture content below at least 12% before the alkyd based stain (using oil based solvents such as petroleum distillate as carrier solvents) can be applied. Otherwise, the moisture inside the wood creates a barrier that prevents the penetration of the alkyd based stain, resulting uneven streaks. In contrast, the base solution (using alcohol based solvents as carrier solvents) does not have such problems, and the nature wood can be easily stained, even the moisture content of the nature wood is still relatively high. Boards of Western Red Cedar (Thuja plicata) (a softwood) with different moisture contents (ranging from 6 to 42%) were treated with the same colored base solution with transparent iron oxides pigments (“red cedar” color) and dried under ambient condition until fully dry (6% moisture content). As shown in FIG. 5, no visual difference in terms of hue or shade is observed when comparing the wood treated with the colored based solution when the wood is dry (6% moisture content) or relatively wet (42% moisture content).

Embodiments described herein are included to demonstrate particular aspects of the present disclosure. It should be appreciated by those of skill in the art that the embodiments described herein merely represent exemplary embodiments of the disclosure. Those of ordinary skill in the art should, in light of the present disclosure, appreciate that many changes can be made in the specific embodiments described and still obtain a like or similar result without departing from the spirit and scope of the present disclosure. From the foregoing description, one of ordinary skill in the art can easily ascertain the essential characteristics of this disclosure, and without departing from the spirit and scope thereof, can make various changes and modifications to adapt the disclosure to various usages and conditions. The embodiments described hereinabove are meant to be illustrative only and should not be taken as limiting of the scope of the disclosure.

What is claimed is:

1. A method for treating green wood, the method comprising:
treating the green wood with a first solution, wherein the first solution comprises at least one miscibility solvent and a solubilizer or a stabilizer; and
air drying the green wood after treating the green wood with the first solution.

2. The method of claim 1, wherein the miscibility solvent is selected from Acetone, Acetonitrile, tent-Butanol, Carbon tetrachloride, Chloroform, Cyclohexane, Cyclopentane, Dichloromethane, Diethyl ether, Ethanol, Ethyl acetate, Ethyl ether, Ethylene dichloride, Heptane, n-Hexane, Methanol, Methylene chloride, Methyl tent-butyl ether, Pentane, Petroleum ethers, Isopropanol, n-Propanol, Tetrahydrofuran or a mixture thereof.

3. The method of claim 2, wherein the solubilizer or the stabilizer is selected from at least one alkoxysilane, metal oxide precursor or a combination thereof having a general formula of M(OR)₄ (M=Si, Al, Ti, In, Sn or Zr), where R comprises hydrogen, a substituted or unsubstituted alkyl, or derivatives thereof.

4. The method of claim 3, wherein the solubilizer or the stabilizer is selected from tetramethyl orthosilicate, tetraethyl orthosilicate, tetraisopropyl orthosilicate, tetra(tert-butyl) orthosilicate, tetra(sec-butyl) orthosilicate, aluminum methoxide, aluminum ethoxide, aluminum isopropoxide, aluminum tert-butoxide, aluminum tri-sec-butoxide, titanium methoxide, titanium ethoxide, titanium isopropoxide, titanium tert-butoxide, titanium tri-sec-butoxide, or derivatives bearing similar structures.

5. The method of claim 1, wherein the treating of the green wood is selected from dipping, soaking, or spraying the green wood with the first solution.

6. The method of claim 1, wherein the treating of the green wood includes applying increased pressure, increased temperature, or both to the green wood to infuse the first solution.

7. The method of claim 1 further comprising preparing the first solution before treating the green wood, wherein the first solution is prepared by mixing all components of the first solution and stirring at a temperature equal to or between 50 to 100° C. for 30 minutes or greater.

8. The method of claim 1, wherein the green wood is treated with the first solution for equal to or between 1 minute to 24 hours.

9. The method of claim 8, wherein green the wood is subjected to the air drying process for equal to or between 1 day or longer.

10. The method of claim 1, wherein the steps of treating the green wood with the first solution and air drying are repeated.

11. The method of claim 1, further comprising the steps of:
treating the green wood with a second solution after the air drying, wherein the second solution is identical to the first solution or different from the first solution; and
kiln drying the green wood after treating the green wood with the second solution.

12. The method of claim 1, wherein the first solution further comprises at least one preservative, chelating agent, bonding agent, pigment, water, or a combination thereof.

13. The method of claim 12, wherein the first solution includes the preservative, and the preservative is an ultraviolet light absorber, hindered-amine light stabilizer, antioxidants, pesticide, fungicide, or biocide.

14. The method of claim 13, wherein the preservative is selected from 2-hydroxyphenyl-benzophenones, 2-(2-hydroxyphenyl)-benzotriazole, 2-hydroxyphenyl-s-triazines derivatives, tetramethyl piperidine derivatives, sterically hindered phenols, phosphites, thioethers, Acid copper chromate, Ammoniacal copper arsenate, Ammoniacal copper citrate, Ammoniacal copper zinc arsenate, Alkaline copper quaternary compounds, Boric acid, Borates complexes, Creosote, Chromated copper arsenate, Copper azoles, Copper dimethyldithiocarbamate, Copper naphthenate, Copper-8-quinolinolate, 3-Iodo-2-propynyl butyl carbamate, Pentachlorophenol, cedar oil, or neem seed oil.

15. The method of claim 12, wherein the first solution includes the chelating agent, and the chelating agent comprises at least one alkoxysilane, metal oxide precursor or a combination thereof having a general formula of M(OR)ₓ R′_{y} R″_{z} (M=Si, Al, In, Sn or Ti; xis the integer 1, 2 or 3; y is the integer 0, 1 or 2; z is the integer 1, 2 or 3, provided that the sum of x, y and z equals 4), where R comprises hydrogen, a substituted or unsubstituted alkyl or derivatives thereof; R′ comprises hydrogen, a substituted or unsubstituted alkyl or derivatives thereof and R″ comprises a substituted or unsubstituted amine (including primary, secondary and tertiary) or thiol.

16. The method of claim 12, wherein the first solution includes the bonding agent, and the bonding agent comprises at least one alkoxysilane, metal oxide precursor or a combination thereof having a general formula of M(OR)ₓ R′_{y} R″_{z} (M=Si, Al, In, Sn or Ti; x is the integer 1, 2 or 3; y is the integer 0, 1 or 2; z is the integer 1, 2 or 3, provided that the sum of x, y and z equals 4), where R comprises hydrogen, a substituted or unsubstituted alkyl or derivatives thereof; R′ comprises hydrogen, a substituted or unsubstituted alkyl or derivatives thereof and R″ comprises a substituted or unsubstituted epoxy or glycidoxy.

17. The method of claim 12, wherein the first solution includes one or more pigments.

18. A method for treating green wood, the method comprising:
preparing a first solution that comprises at least one preservative selected from an ultraviolet light absorber, hindered-amine light stabilizer, antioxidants, pesticide, fungicide, or biocide; wherein the first solution further comprises at least one miscibility solvent and a solubilizer or a stabilizer, and wherein further the first solution is prepared by mixing all components of the first solution and stirring at an elevated temperature for a set period of time;
treating the green wood with the first solution wherein the treating of the green wood is selected from dipping, soaking, or spraying the green wood with the first solution or applying increased pressure, increased temperature, or both to the green wood to infuse the first solution;
air drying the green wood after treating the green wood with the first solution;
treating the green wood with a second solution after the air drying, wherein the second solution shares the same components as the first solution or is different from the first solution; and
kiln drying the green wood after treating the green wood with the second solution.

19. The method of claim 18, wherein the miscibility solvent is selected from Acetone, Acetonitrile, tent-Butanol, Carbon tetrachloride, Chloroform, Cyclohexane, Cyclopentane, Dichloromethane, Diethyl ether, Ethanol, Ethyl acetate, Ethyl ether, Ethylene dichloride, Heptane, n-Hexane, Methanol, Methylene chloride, Methyl tent-butyl ether, Pentane, Petroleum ethers, Isopropanol, n-Propanol, Tetrahydrofuran or a mixture thereof.

20. The method of claim 18, wherein the preservative is selected from 2-hydroxyphenyl-benzophenones, 2-(2-hydroxyphenyl)-benzotriazole, 2-hydroxyphenyl-s-triazines derivatives, tetramethyl piperidine derivatives, sterically hindered phenols, phosphites, thioethers, Acid copper chromate, Ammoniacal copper arsenate, Ammoniacal copper citrate, Ammoniacal copper zinc arsenate, Alkaline copper quaternary compounds, Boric acid, Borates complexes, Creosote, Chromated copper arsenate, Copper azoles, Copper dimethyldithiocarbamate, Copper naphthenate, Copper-8-quinolinolate, 3-Iodo-2-propynyl butyl carbamate, Pentachlorophenol, cedar oil, or neem seed oil.
